(19) United States
(12) Patent Application Publication
(10) Pub. No.: US 2026/0051754 A1
(43) Pub. Date: Feb. 19, 2026

(54) BATTERY ADAPTER UNIT

(71) Applicant: BUSHNELL INC., Overland Park, KS (US)

(72) Inventors: Laurie A. Kokoruda, Overland Park, KS (US); Joe Dunning, Oroville, CA (US)

(21) Appl. No.: 18/808,580

(22) Filed: Aug. 19, 2024

(51) Int. Cl. H02J 7/00; F41J 9/18

(52) U.S. Cl. CPC H02J 7/0044; F41J 9/18; H02J 7/0063; H02J 7/007182; H02J 2207/20

(57) ABSTRACT

A battery adapter unit for an automatic clay thrower including a housing defining a battery receptacle area having a pair of input terminals to engage with battery contacts of a replacement battery and a first pair of protrusions defining a first recess therebetween; a slidable lever defining a catch to engage a corresponding projection on the replacement battery to slide with the replacement battery between a first position and second position when the catch is engaged with the projection, the projection corresponding to the rated voltage of the replacement battery; a pair of output terminals, one of the output terminals mounted in the first recess; and a circuit configured to be electrically connected to the replacement battery via the input terminals and to the output terminals, the circuit configured to adjust the voltage from the replacement battery and supplied to the output terminals.

### FIELD OF TECHNOLOGY

The present disclosure generally relates to a battery adapter unit, and more particularly to a battery adapter unit for mounting a replacement battery, such as a lithium ion battery, on a host apparatus designed for use with a different battery type, such as a lead acid (L/A) battery.

### BACKGROUND OF TECHNOLOGY

Many electromechanical or motorized devices used for outdoor activities require batteries for mobile power. For example, equipment such as automatic clay throwers require battery power. An automatic clay thrower launches clay pigeons into the air to produce a flying target. An automatic clay thrower can fling a clay pigeon a distance of up to 50-70 yards. Automatic clay throwers are fully automated, electrically powered machines that will throw a clay pigeon every time a remote button is pressed or an acoustic sensor is operated to produce consistent targets, allow greater target flexibility and increase operator safety.

Automatic clay throwers typically are designed to operate with deep cycle battery L/A batteries. For example, automatic clay throwers can provide cycle times of 1-2.5 seconds per cycle and 20-60 cycles per minute. Automatic clay throwers may be operated for throwing multiple clay pigeons over time. Accordingly, L/A deep-cycle batteries are designed to produce steady power output, which discharges the battery significantly, at which point it must be recharged to complete the cycle. L/A batteries are desirable because they are inexpensive.

However, L/A batteries have relatively low energy density and thus can be large and heavy, and suffer from relatively short cycle lifespan (usually less than 500 deep cycles) and overall lifespan, as well as long charging times. What is needed is a battery adapter unit that allows automatic clay throwers and other battery-powered electromechanical devices to use more efficient batteries than those for which they may have been originally designed, without damage to the electromechanical device, and which overcomes the disadvantages of conventional design.

### SUMMARY OF DESCRIBED SUBJECT MATTER

Embodiments of the present disclosure include a battery adapter unit for adapting a replacement battery of a first type for powering an automatic clay thrower designed to operate with a battery of a second type, wherein the first and second battery types are different, including a housing having an upper housing portion defining a battery receptacle area having a pair of input terminals to engage with battery contacts of the replacement battery and a lower housing portion having a first pair of protrusions defining a first recess therebetween; a lever slidably disposed in the battery receptacle area and defining a catch to engage a corresponding projection on the replacement battery when slidably received in the battery receptacle area and to partially slide with the replacement battery between a first position and second position when the catch is engaged with the projection, the projection corresponding to the rated voltage of the replacement battery; a pair of output terminals mounted to the housing for electrical connection to the automatic clay thrower; one of the output terminals mounted in the first recess; and a circuit configured to be electrically connected to the replacement battery via the input terminals and to the pair of output terminals, the circuit including a transformer configured to adjust the voltage provided from the replacement battery and supplied to the output terminals; and a switch responsive to the lever to connect or disconnect the transformer from the circuit in response to the position of the lever.

In some embodiments, the battery of the first type is a Lithium-ion battery. In some embodiments, the battery of the second type is a lead acid battery.

In some embodiments, the automatic clay thrower is configured to operate in an operating voltage, and the switch is configured to disconnect the transformer from the circuit based on the detected rated voltage of the battery of the first type. In some embodiments, the switch is configured to disconnect the transformer from the circuit if the detected rated voltage of the battery of the first type is within the operating voltage. In some embodiments, the operating voltage of the automatic clay thrower is 12V and the switch responsive to the lever is configured to disconnect the transformer from the circuit in response to the signal of the detector when the detected voltage of the battery is 12V.

In some embodiments, the lever is configured to advance an actuator on the switch between a first position and a second position to toggle the switch responsive to the movement of the lever.

In some embodiments, the output terminals each comprise a rod shape. In some embodiments, one or more of the output terminals defines a textured surface. In some embodiments, the housing defines one or more through holes for mounting.

In another aspect, embodiments of the present disclosure include a battery adapter unit for adapting a replacement battery of a first type for powering an automatic clay thrower designed to operate with a battery of a second type, wherein the first and second battery types are different, including a housing having an upper housing portion defining a battery receptacle area having a pair of input terminals to engage with battery contacts of the replacement battery and a lower housing portion having a first pair of protrusions defining a first recess therebetween wherein the first recess is defined by a side wall of each of the first pair of protrusions and a housing wall; a lever slidably disposed in the battery receptacle area and defining a catch to engage a corresponding projection on the replacement battery when slidably received in the battery receptacle area and to partially slide with the replacement battery between a first position and second position when the catch is engaged with the projection, the projection corresponding to the rated voltage of the replacement battery; a pair of output terminals mounted to the housing for electrical connection to the automatic clay thrower; one of the output terminals mounted in the first recess, wherein each end of the one of the output terminals is mounted to the side wall of each of the first pair of protrusions; and a circuit configured to be electrically connected to the replacement battery via the input terminals and to the pair of output terminals, the circuit including a transformer configured to adjust the voltage provided from the replacement battery and supplied to the output terminals; and a switch responsive to the lever to connect or disconnect the transformer from the circuit in response to the position of the lever.

In some embodiments, the output terminal is substantially parallel to the housing wall and recessed from the end wall of the respective protrusions. In some embodiments, the battery of the first type is a Lithium-ion battery. In some embodiments, the battery of the second type is a lead acid battery.

In some embodiments, the automatic clay thrower is configured to operate in an operating voltage, and wherein the switch is configured to disconnect the transformer from the circuit based on the detected rated voltage of the battery of the first type. In some embodiments, the switch is configured to disconnect the transformer from the circuit if the detected rated voltage of the battery of the first type is within the operating voltage.

In a further aspect, embodiments of the present disclosure include a battery adapter unit for adapting a replacement battery of a first type for powering a host apparatus designed to operate with a battery of a second type, wherein the first and second battery types are different, including: a housing having an upper housing portion defining a battery receptacle area having a pair of input terminals to engage with battery contacts of the replacement battery and a lower housing portion having a first pair of protrusions defining a first recess therebetween; a lever slidably disposed in the battery receptacle area and defining a catch to engage a corresponding projection on the replacement battery when slidably received in the battery receptacle area and to partially slide with the replacement battery between a first position and second position when the catch is engaged with the projection, the projection corresponding to the rated voltage of the replacement battery; a pair of output terminals mounted to the housing for electrical connection to the host apparatus; one of the output terminals mounted in the first recess; and a circuit configured to be electrically connected to the replacement battery via the input terminals and to the pair of output terminals, the circuit including a transformer configured to adjust the voltage provided from the replacement battery and supplied to the output terminals; and a switch responsive to the lever to connect or disconnect the transformer from the circuit in response to the position of the lever.

In some embodiments, the battery of the first type is a Lithium-ion battery. In some embodiments, the battery of the second type is a lead acid battery. In some embodiments, the host apparatus is configured to operate in an operating voltage, and wherein the switch is configured to disconnect the transformer from the circuit based on the detected rated voltage of the battery of the first type.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is an upper isometric view of a battery adapter unit in accordance with exemplary embodiment of the disclosed subject matter.

FIG. 2 is a top plan view thereof.

FIG. 2A is an enlarged top plan view of a portion of the battery adapter unit of FIG. 2.

FIG. 2B is an enlarged top plan view of another portion of the battery adapter unit of FIG. 2.

FIG. 3 is a side view of the battery adapter unit of FIG. 1.

FIG. 4 is a front elevation view thereof.

FIG. 5 is a rear elevation view thereof.

FIG. 6 is a bottom plan view thereof.

FIG. 7 is an enlarged view illustrating a battery in relation to the upper portion of the battery adapter unit of FIG. 1.

FIG. 8 is an enlarged partial view of a bottom surface of a prior art battery for use with the battery adapter unit of FIG. 1.

FIG. 9 is an upper isometric view of the battery adapter unit of FIG. 1, illustrating a battery attached thereto and a host apparatus.

FIG. 10 is an upper isometric view, illustrating a set of clamps secured to the terminals of the battery adapter unit.

FIG. 11 is an enlarged view of a clamp secured to a terminal of the battery adapter unit.

FIG. 12 is an upper isometric view of the battery adapter unit of FIG. 1, illustrating the upper housing portion removed, and conducting wires not shown for clarity of illustration.

FIG. 13 is an enlarged side of view a voltage lever and a switch unit.

FIG. 14 is a simplified schematic view of the circuitry of the battery adapter unit of FIG. 1

FIG. 15 an upper isometric view, illustrating the upper housing portion opened and the switch in a first configuration.

FIG. 16 an upper isometric view, illustrating the upper housing portion opened and the switch in a second configuration.

### DETAILED DESCRIPTION

While the cost and availability of deep cycle L/A batteries have been compelling for many portable electromechanical devices as their power source, lithium-ion (Li-ion) battery technology has improved in recent years from personal electronics to industrial applications as a preferred choice. Li-ion batteries are considered to perform comparably or better than other rechargeable battery technology, including but not limited to usable capacity, life cycle, charging time, and operational expenditure (OPEX). Lithium provides the largest energy density per volume and weight among commonly used rechargeable batteries.

Due to the significant development in Li-ion battery technology, the demand for replacing conventional L/A batteries with modern Li-ion based technology is rapidly increasing. Lithium batteries can be charged in a normal indoor environment and have no requirements for special rooms that can withstand acid fumes associated with charging L/A batteries. Substitution of Li-ion batteries can reduce battery size, and significantly increase cycle and calendar life as much 3 times compared with L/A batteries.

A battery adapter unit that facilitates the substitution of a replacement battery, such as a Li-ion battery to replace the original battery, such as a deep cycle L/A battery, is disclosed herein. Various detailed embodiments of the present disclosure, taken in conjunction with the accompanying figures, are disclosed; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or” or with the conjunction “and.” In either case, the set is to be interpreted as meaning each of the items singularly as alternatives, as well as any combination of the listed items.

As used herein, the term “top” or “upper” portion refers to the portion of the battery adapter unit that is intended to engage with the battery, and often furthest from the ground or floor surface. Conversely, the term “bottom” or “lower” portion refers to the portion of the battery adapter unit furthest from the mounting of the battery and often nearest to the ground or floor surface when in use. The term “front” refers to the side of the battery adapter unit in which the battery is inserted to the battery adapter, whereas the term “rear” refers to the region opposite the front. The “sides” refer to the sides of the battery adapter unit between the front and rear portions. The term “longitudinal” refers to an axis extending generally from the front of the battery adapter unit to the rear. The term “downward” refers to an axis extending generally from the top of the battery adapter unit to the bottom.

As used herein, the term “host apparatus” denotes a battery-powered device, such as an mobile electromechanical device, e.g., an automatic clay thrower, that is powered by the replacement battery via the battery adapter unit. The term “original” battery denotes the type of battery for which the host apparatus is designed. In some embodiments, the original battery system is L/A deep cycle batteries. The term “replacement” battery denotes the type of battery that is intended as a substitution of the original battery, and for which the adapter is intended to allow usage with the host apparatus. In some embodiments, the replacement battery is a Li-ion battery.

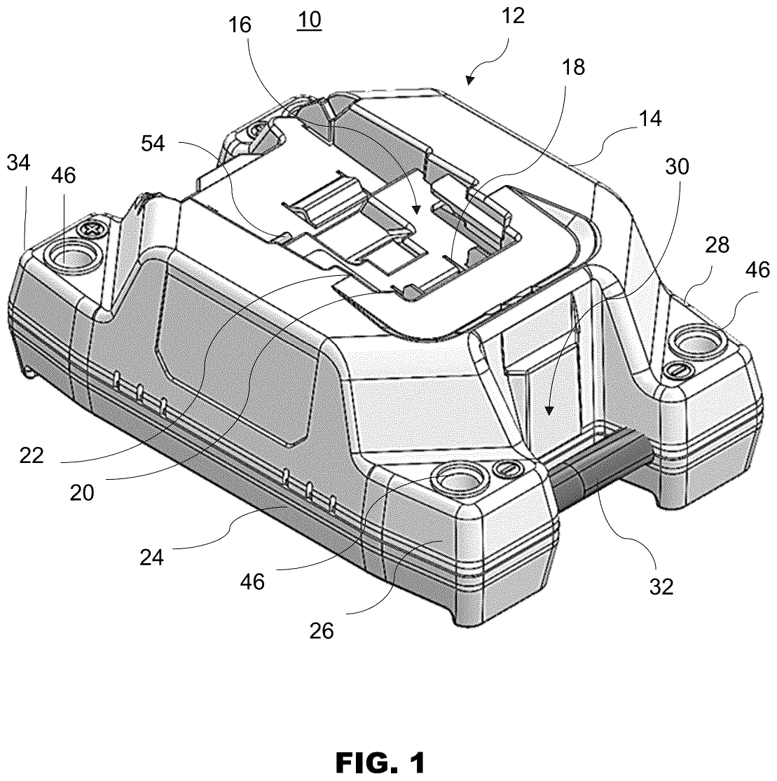

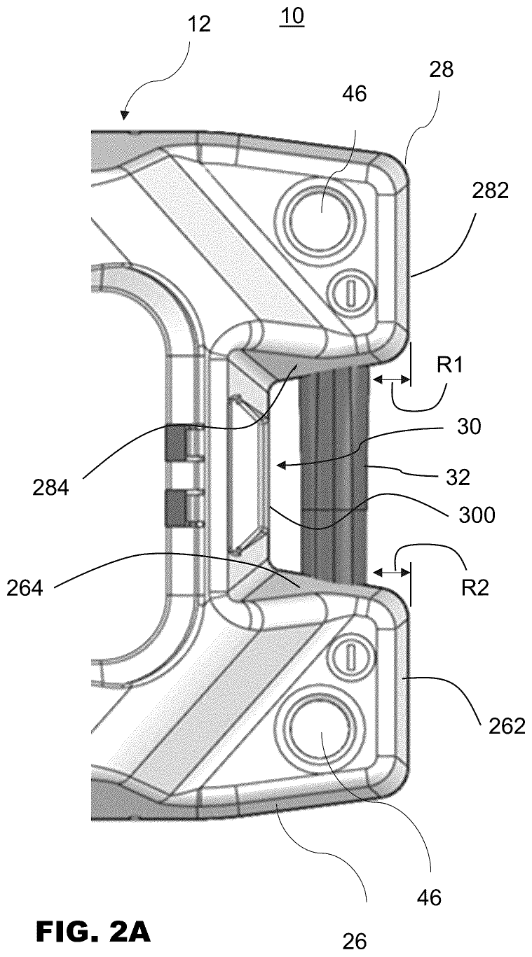

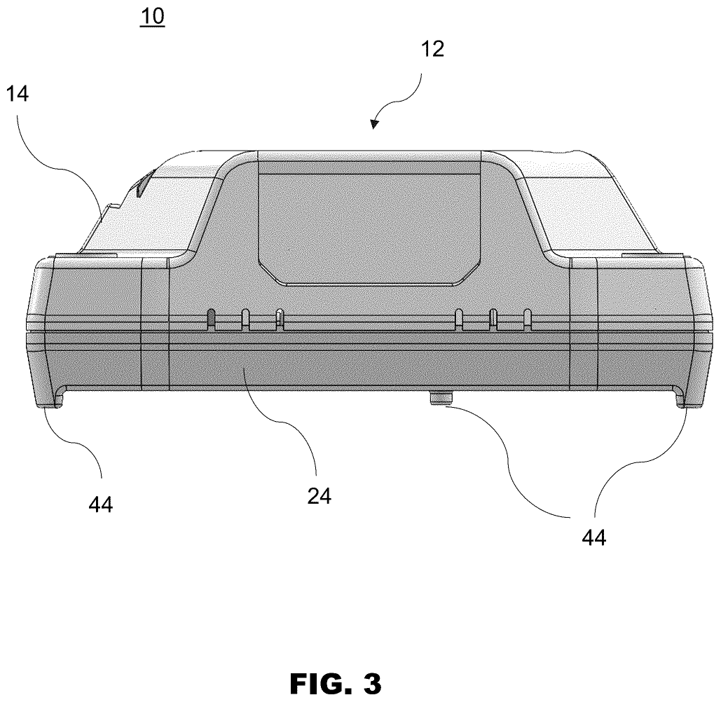

FIGS. 1-6 illustrate an exemplary battery adapter unit 10 to adapt a battery of a second type, a replacement battery, for use with a host apparatus originally designed to use a battery of a first type, an original battery. In an exemplary embodiment, the battery adapter unit 10 is designed to adapt a Li-ion battery, such as a rechargeable drill battery, for use as a replacement battery with a clay thrower originally intended to operate with a L/A deep cycle battery such as a marine battery as the original battery type. It is understood that the adapter unit described herein is intended for use with a variety of host apparatuses and to adapt a number of different battery types, including L/A, Li-ion and nickel cadmium (NiCad) batteries. For example, the demands of the automatic clay thrower can include units that can provide run times of 13 minutes with 1.76 seconds per cycle and 34 cycles per minute with no clays. When clays are thrown, the demands are 2.5 seconds per cycle at 24 cycles per minute. Other exemplary clay throwers include specifications of 2 seconds per cycle at 30 cycles per minute; 1.75 seconds per cycle at 34 cycles per minute; and 1 second per cycle at 60 cycles per minute. A replacement battery of the second type, such as a Li-ion battery, can meet those demands usually provided by a marine-type L/A battery.

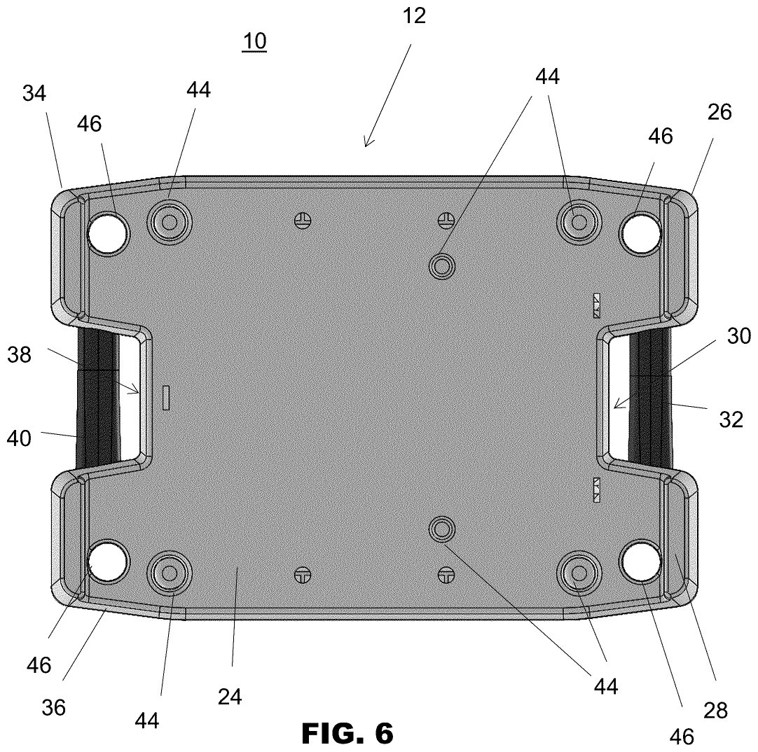

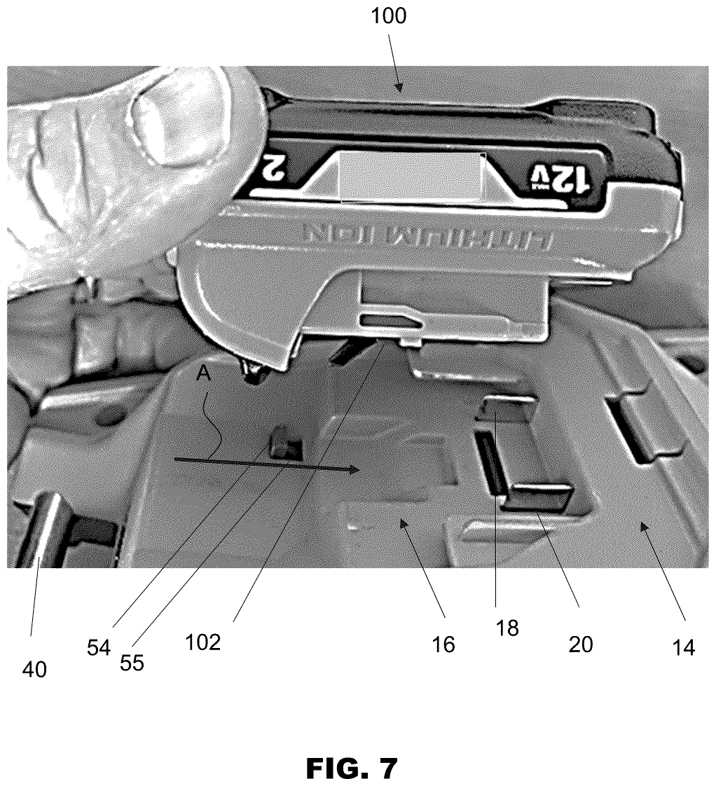

As illustrated in FIGS. 1-6 battery adapter unit 10 includes a housing 12 having an upper housing portion 14 and lower housing portion 24. The housing 12 is fabricated from ABS, nylon or similar materials. The upper housing portion 14 includes a recessed area, such as battery receptable area 16 that includes a shape configured to conform to the replacement battery 100 (shown in FIGS. 7-9). Input terminals 18 and 20 are provided within the battery receptacle 16 and are designed to make contact with the battery contacts 104/106 of the battery 100. As shown in FIG. 8, an exemplary Li-ion battery 100 includes longitudinal slots 108/110 on the bottom surface 102 in which battery contacts 104 and 106 are recessed. In some embodiments, the receptacle area 16 includes a contour flange 22 designed to engage with a complementary contour flange 112 on the battery 100 when the battery 100 is advanced in the longitudinal direction denoted by arrow A (See FIG. 7) on the battery adapter unit 10, and which direct the input terminals 18/20 into conductive engagement with battery contacts 104/106 within the slots 108/110.

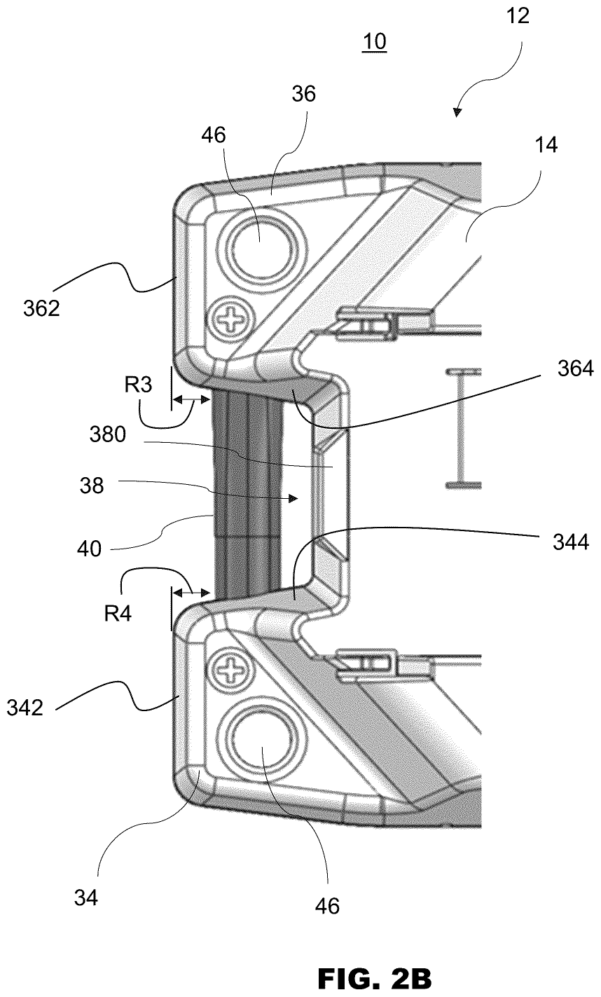

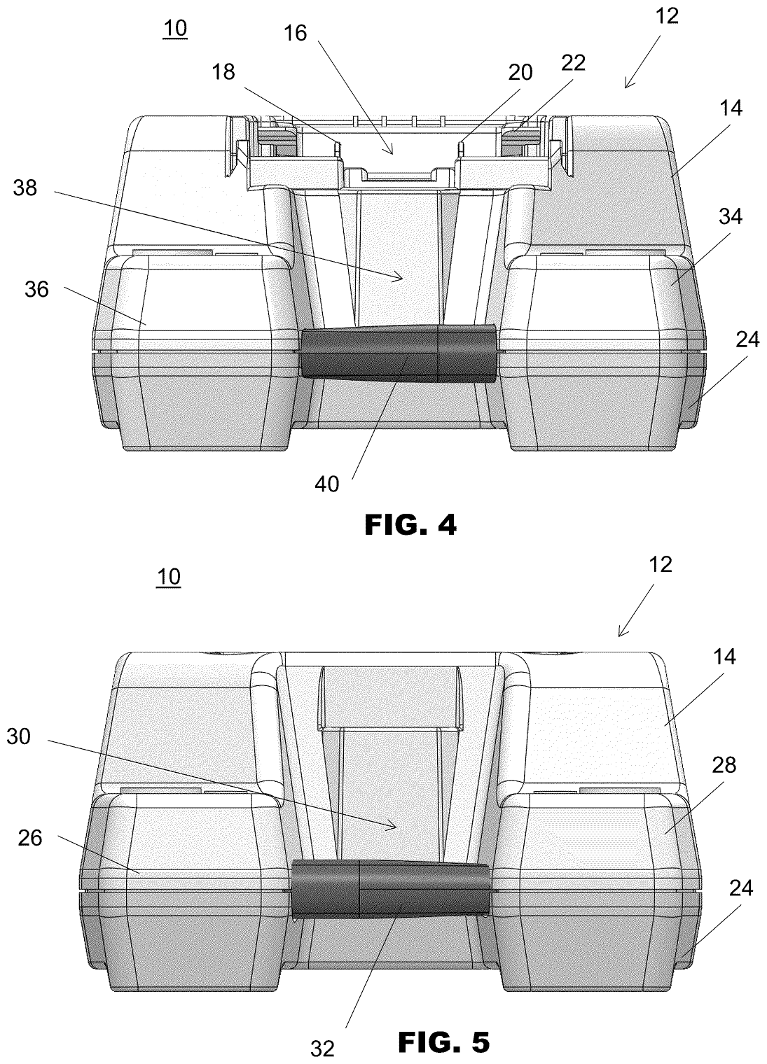

The battery adapter unit 10 is advantageously used in an outdoor environment with an automatic clay thrower. As such the housing unit 12 can include four laterally outwardly projecting protrusions 26, 28, 34, 36 to provide a secure footing on the ground. On the front side of the unit 10, the housing 12 includes protrusions 34 and 36. On the rear side of the unit 10, the housing 12 includes protrusions 26 and 28. The housing unit 12 may include a plurality of mounting bore through-holes 46 in each of protrusions 26, 28, 34, 36, measuring approximately 5/16 inch in diameter, to allow, for example, the use of stakes or bolts to secure the unit 10 to the ground or to another platform. Stakes inserted through the holes 46 can be used to secure the unit 10 to the ground, and screws or bolts can be used to secure the unit 10 to a block of wood or some other object to create a mounting assembly (not shown) to secure the unit 10 to the clay thrower. A plurality of downwardly-extending feet 44 (see FIGS. 4 and 6) help provide further stability to the housing 12.

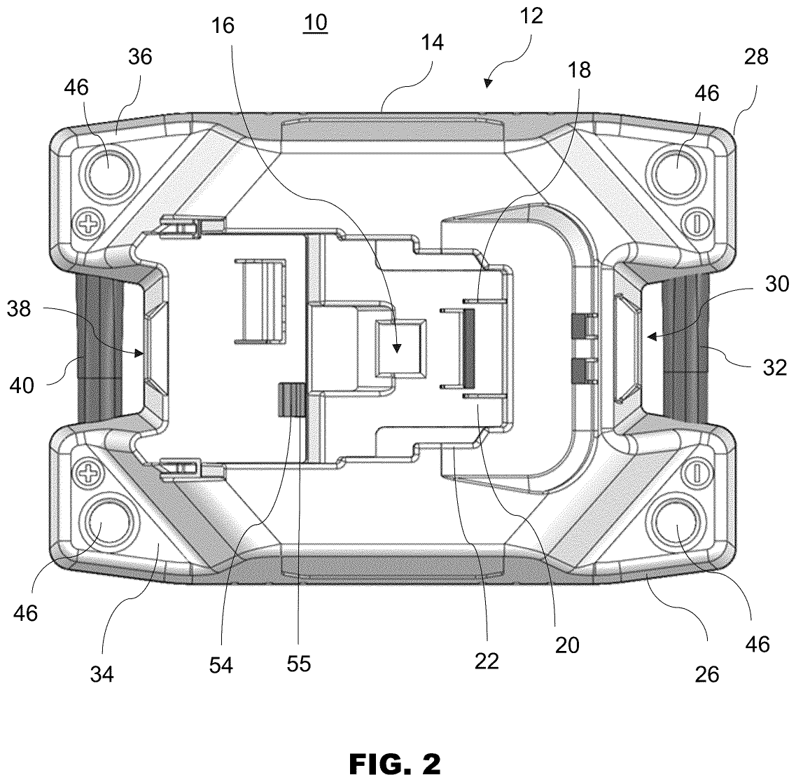

As shown in FIGS. 2 and 2A, a recess 30 is defined on the rear side of the unit 10 between the protrusions 26 and 28 in which a negative output terminal 32 is positioned. Similarly, as shown in FIGS. 2 and 2B, on the front side of the unit 10, a recess 38 is defined between the protrusions 34 and 36 in which a positive output terminal 40 is positioned. It is understood that the polarity of the terminals 32 and 40 can be reversed as is known in the art. Positioning of the output terminals 32 and 40 in the recesses 30 and 38, respectively, provides a secure location for the attachment of clamps that is disposed out of the way and provides protection against accidental dislodgement of the clamps. As illustrated in greater detail in FIG. 2A, recess 30 is defined by inner side wall 284, back wall 300 and inner side wall 264. In some embodiments, walls 264, 284 and 300 are substantially planar and define a substantially three-sided recess 30. Recess 38 similarly has a configuration defined by inner side wall 364, back wall 380 and inner side wall 344 (FIG. 2B).

The output terminals 32 and 40 are each a conductive, metallic rod or bar for attachment of alligator clamps that are typically intended for securement to the battery contacts of a L/A marine type battery to the automatic clay thrower. Output terminals 32 and 40 are each positioned within the respective recesses 30 and 38. In some embodiments, each end of an output terminal is mounted to the side wall of each of the protrusions and is substantially parallel to the respective back wall of the recess. The attachment point of the terminal is set back from the end portion of the respective projections. As shown in FIGS. 2 and 2A, each end of output terminal 32 is attached to side walls 284 and 264. Output terminal 32 is substantially parallel to back wall 300 and recessed from the end wall 282 of protrusion 28 by a distance R1 and from the end wall 262 of protrusion 26 by a distance R2. Similarly, as shown in FIGS. 2 an 2B, each end of output terminal 40 is attached to side walls 364 and 344. Output terminal 40 is substantially parallel to back wall 380 and recessed from the end wall 362 of protrusion 36 by a distance R3 and from the end wall 342 of protrusion 34 by a distance R4.

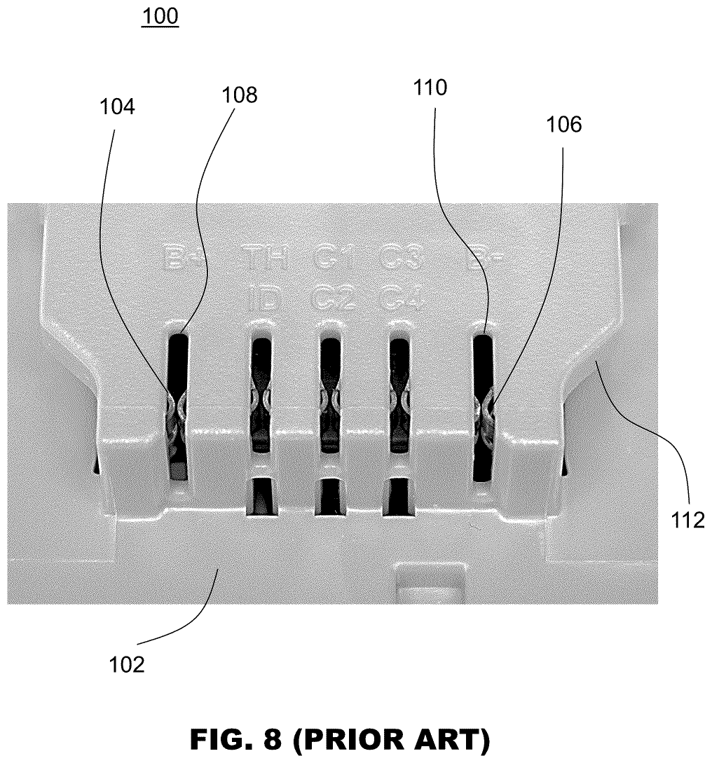

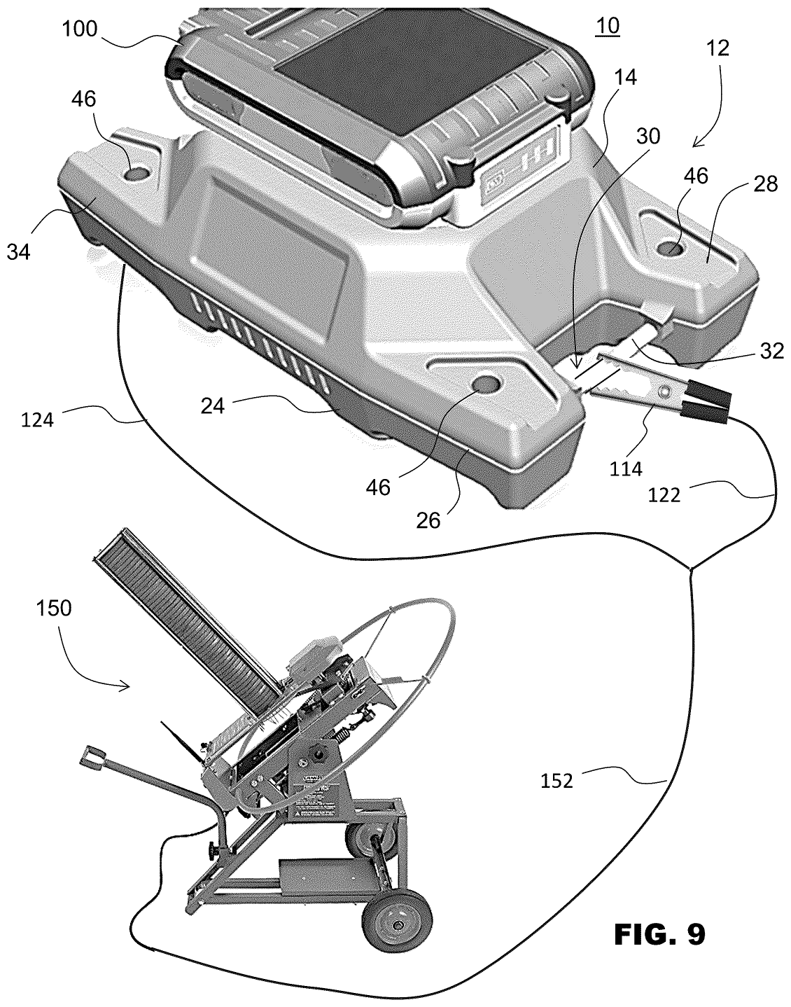

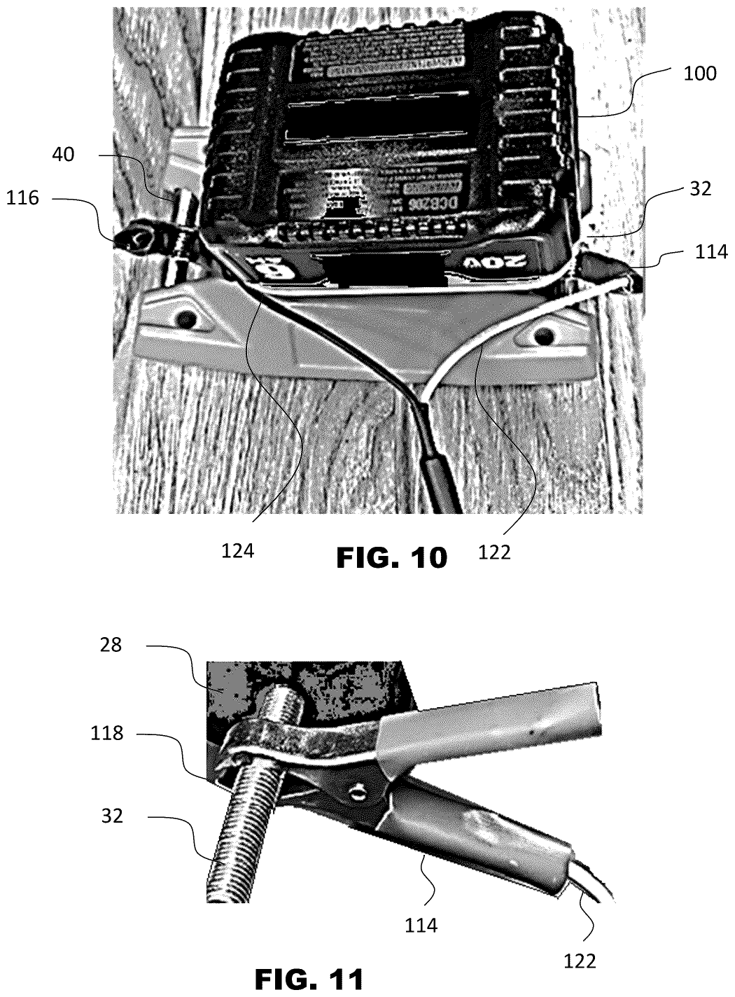

In some embodiments, the output terminals 32 and 40 each have a textured surface, e.g., a roughened surface, or a surface including threading, fluting or ridges to provide frictional securement of the clamp to the terminal. As illustrated in FIGS. 9, the batter adapter unit 10 is connected to the automatic clay thrower 150 by means of a pair of wires 122 and 124 terminating in clamps 114 and 116. (The battery adapter unit 10 and automatic clay thrower 150 are not shown to scale in FIG. 9.) Wires 122 and 124 provide electrical connection between the batter adapter unit 10 and the automatic clay thrower 150 and are partially encased in a sheath 152 for convenience. As shown in FIGS. 9-11, a pair of clamps, such as alligator clamp 114 and 116, are secured respectively to output terminals 32 and 40. Each alligator clamp 114 and 116 includes jaws 118 that are secured to the output terminals 32 and 40.

When the battery adapter unit 10 is used with a replacement battery 100, the rated voltage of the replacement battery being used can vary, depending upon the battery the user has at hand. For example, a voltage of 12V is a common voltage for which a host apparatus, such as a clay thrower, is designed to operate. The “operating voltage” is understood to be a percentage range above and below 12V. However, replacement batteries can be rated with other voltages, including higher voltages such as 18V or 20V. If the voltage of the replacement battery is greater than the designed operating voltage, it can have a detrimental impact on the operation of the host apparatus. For example, batteries with higher voltages may harm the motor of the automatic clay thrower. Accordingly, a system is provided in the battery adapter unit 10 to detect and compensate for such variations in voltage of the replacement battery.

In some embodiments, detection of the rated voltage of the replacement battery is provided. A voltage lever 42 is designed to interact with a corresponding projection on the replacement battery. For example, batteries rated at the operational voltage of the host apparatus may have a raised tab or bump 122 on the bottom surface 102 that denotes the rated voltage. Batteries with higher voltage rating do not have such a raised tab or bump. For example, with a desired operating voltage of 12V, batteries rated at 12V would have a raised tab or bump, whereas batteries with 18V or 20V voltage ratings would not have the raised tab or bump.

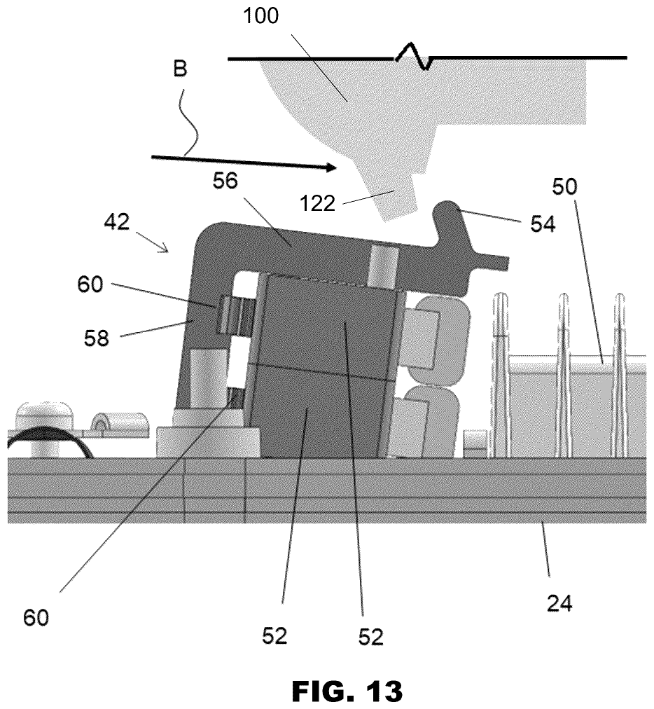

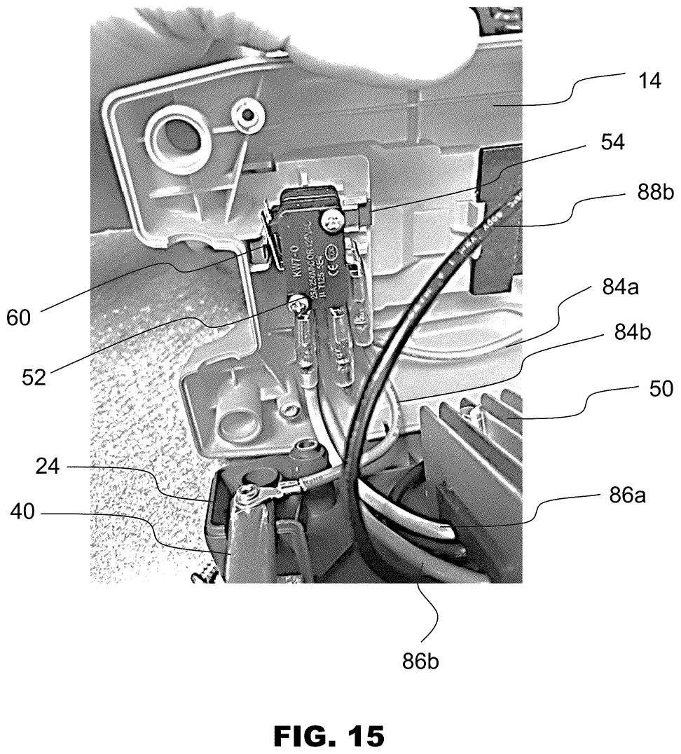

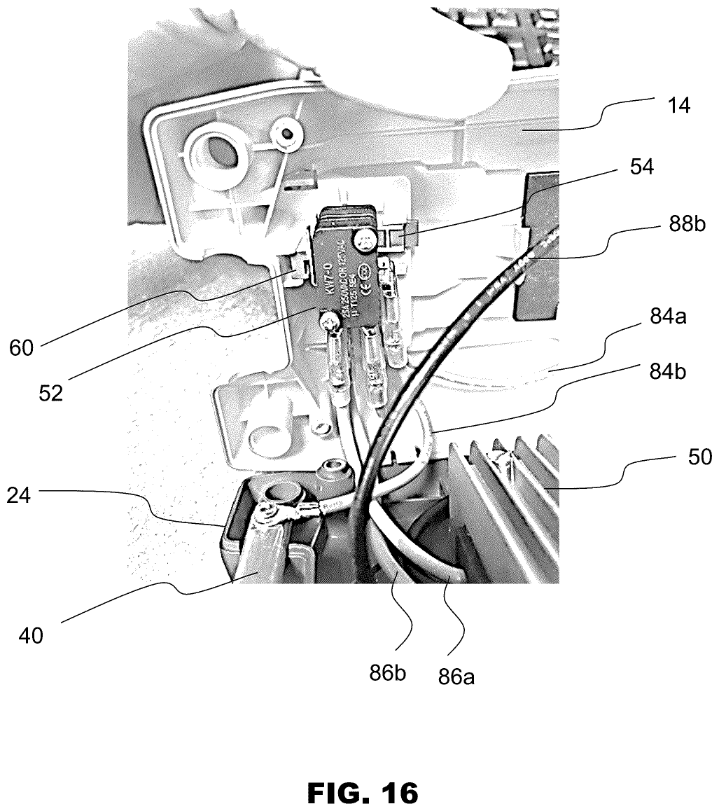

As illustrated in FIGS. 2 and 12-13, the battery adapter unit 10 is configured to operate in an operating voltage, such as 12V, and is provided with a switch 52 configured to disconnect a transformer 50 from the circuitry 80 if the detected rated voltage of the replacement battery is within the voltage range, e.g., 12V. (In some embodiments, the opposite configuration is provided: the battery adapter unit 10 is provided with a switch configured to disconnect a transformer from the circuitry if the detected rated voltage of the replacement battery is outside the operating voltage range.) Accordingly, the voltage lever 42 includes a catch 54 that extends through an aperture 55 in the upper housing 14 into the receptacle area 16. As illustrated in FIG. 13, the lever 42 is slidably mounted on bottom housing portion 24. The lever 42 has an inverted “L”-shaped configuration including a horizontal portion 56 and a vertical portion 58. When a battery of the desired voltage, e.g., 12V, is positioned within the receptacle area 16, the raised tab or bump 122 is engaged by the catch 54 of the lever 42. As the battery 100 is advanced in the direction A (shown in FIG. 7) into engagement with the input terminals 18/20, the lever 42 is simultaneously moved with the battery, in the direction B (shown in FIG. 13). A pair of switches 52 are provided in the housing having sliding actuators 60 movable between a first position and a second position, and that engage with the vertical portion 58 of the lever 42. When the lever 42 is advanced longitudinally, the actuators 60 also move longitudinally from the first position to the second position and toggle the switches 52 to the “off” position. (See also FIG. 16, which illustrates the lever 52 advanced to toggle the switches 52 to the “off” position.) A pair of switches 52 can be provided to add redundancy. If a replacement battery having a different voltage is used, such batteries will not have a raised tab or bump. In such case, the lever 42 will not be advanced, and thus the actuators 60 will remain in the first position. The switches 52 will remain in the “on” position. (See also FIG. 15, which illustrates that the lever 52 is not advanced, such that the switches 52 remain in the “on” position.)

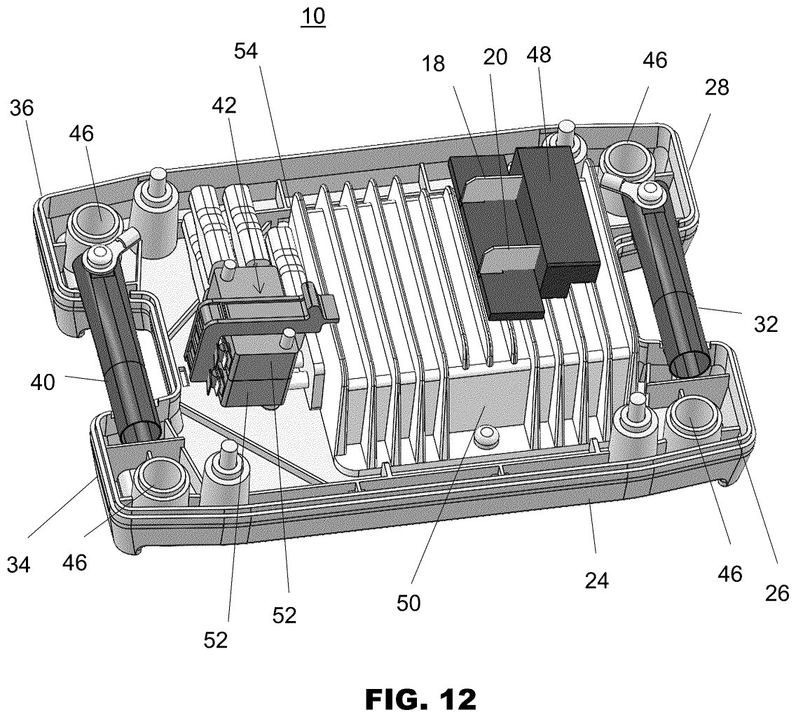

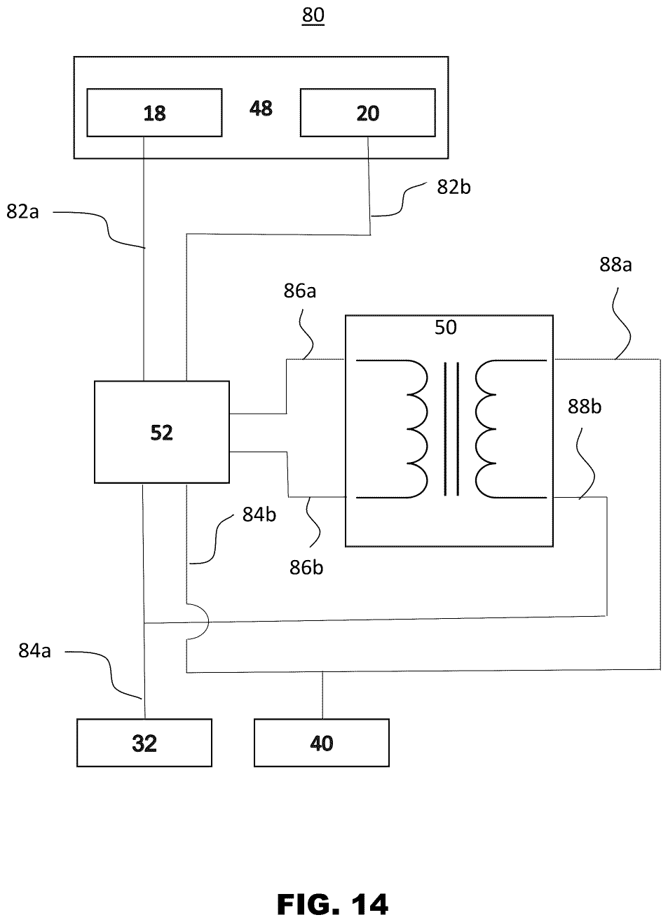

FIG. 14 represents a schematic view of the circuitry 80 shown in FIGS. 12-13 and 15-16. The circuitry 80 shown in FIG. 14 provides compensation for the different voltages provided by various replacement batteries. The input terminals 18/20 are housed in a battery receptacle unit 48. Electrical connection 82a/b is made between the input terminals 18/20 and the switches 52. (One switch is shown in FIG. 14.) As described above, switch 52 interacts with the lever 42 that toggles the switch 52 between the “on” and “off” position.

In the “off” position, the voltage of the replacement battery is the same as or within the designed operating voltage of the host apparatus, e.g., 12V. In such case, the voltage is transferred directly to output terminals 32 and 40 via connections 84a and 84b. In the “on” position, the voltage of the replacement battery is different (typically higher) than the designed operating voltage of the host apparatus. In such case, the switches 52 are electrically connected to transformer 50 by electrical connections 86a and 86b. A voltage adjustment (e.g., a step-down) is made by the transformer 50, and electrical connection is made to the output terminals 32/40 via electrical connections 88a and 88b. The electrical connections 82a/b, 84a/b, 86a/b and 88a/b are conductive elements, typically wires.

In some embodiments, the battery adapter unit includes a manual switch with user input for selecting the voltage rating of the replacement battery. For example, the user may toggle the manual switch to a first position, corresponding to “off” position if the voltage of the replacement battery is the same as the designed operating voltage of the host apparatus. The user may toggle the switch to a second position, corresponding to the “on” position if the voltage of the replacement battery is different (typically higher) than the designed operating voltage of the host apparatus.

In some embodiments, the battery adapter unit includes an optical sensor for detecting the rated voltage of the replacement battery. For example, the replacement battery may include a “QR” code or similar code that may be detected by an optical sensor in the battery receptacle area.

In some embodiments, the battery adapter unit includes a voltage sensor for detecting the voltage of the replacement battery. For example, the replacement battery may include a sensor disposed across input terminals 18 and 20 to detect the voltage generated by the replacement battery.

While one or more embodiments of the present disclosure have been described, it is understood that these embodiments are illustrative only, and not restrictive, and that many modifications may become apparent to those of ordinary skill in the art.

1. A battery adapter unit for adapting a replacement battery of a first type for powering an automatic clay thrower designed to operate with a battery of a second type, wherein the first and second battery types are different, comprising:
a housing comprising an upper housing portion defining a battery receptacle area having a pair of input terminals to engage with battery contacts of the replacement battery and a lower housing portion having a first pair of protrusions defining a first recess therebetween;
a lever slidably disposed in the battery receptacle area and defining a catch to engage a corresponding projection on the replacement battery when slidably received in the battery receptacle area and to partially slide with the replacement battery between a first position and second position when the catch is engaged with the projection, the projection corresponding to the rated voltage of the replacement battery;
a pair of output terminals mounted to the housing for electrical connection to the automatic clay thrower; one of the output terminals mounted in the first recess; and
a circuit configured to be electrically connected to the replacement battery via the input terminals and to the pair of output terminals, the circuit comprising:
a transformer configured to adjust the voltage provided from the replacement battery and supplied to the output terminals; and
a switch responsive to the lever to connect or disconnect the transformer from the circuit in response to the position of the lever.

2. The battery adapter unit of claim 1, wherein the battery of the first type is a Lithium-ion battery.

3. The battery adapter unit of claim 1, wherein the battery of the second type is a lead acid battery.

4. The battery adapter unit of claim 1, wherein the automatic clay thrower is configured to operate in an operating voltage, and wherein the switch is configured to disconnect the transformer from the circuit based on the detected rated voltage of the battery of the first type.

5. The battery adapter unit of claim 4, wherein the switch is configured to disconnect the transformer from the circuit if the detected rated voltage of the battery of the first type is within the operating voltage.

6. The battery adapter unit of claim 4, wherein the operating voltage of the automatic clay thrower is 12V and the switch responsive to the lever is configured to disconnect the transformer from the circuit in response to the signal of the detector when the detected voltage of the battery is 12V.

7. The battery adapter unit of claim 1, wherein the lever is configured to advance an actuator on the switch between a first position and a second position to toggle the switch responsive to the movement of the lever.

8. The battery adapter unit of claim 1, wherein the output terminals each comprise a rod shape.

9. The battery adapter unit of claim 1, wherein one or more of the output terminals defines a textured surface.

10. The battery adapter unit of claim 1, wherein the housing defines one or more through holes for mounting.

11. A battery adapter unit for adapting a replacement battery of a first type for powering an automatic clay thrower designed to operate with a battery of a second type, wherein the first and second battery types are different, comprising:
a housing having an upper housing portion defining a battery receptacle area having a pair of input terminals to engage with battery contacts of the replacement battery and a lower housing portion having a first pair of protrusions defining a first recess therebetween wherein the first recess is defined by a side wall of each of the first pair of protrusions and a housing wall;
a lever slidably disposed in the battery receptacle area and defining a catch to engage a corresponding projection on the replacement battery when slidably received in the battery receptacle area and to partially slide with the replacement battery between a first position and second position when the catch is engaged with the projection, the projection corresponding to the rated voltage of the replacement battery;
a pair of output terminals mounted to the housing for electrical connection to the automatic clay thrower; one of the output terminals mounted in the first recess, wherein each end of the one of the output terminals is mounted to the side wall of each of the first pair of protrusions; and
a circuit configured to be electrically connected to the replacement battery via the input terminals and to the pair of output terminals, the circuit comprising:
a transformer configured to adjust the voltage provided from the replacement battery and supplied to the output terminals; and
a switch responsive to the lever to connect or disconnect the transformer from the circuit in response to the position of the lever.

12. The battery adapter unit of claim 11, wherein the output terminal is substantially parallel to the housing wall and recessed from the end wall of the respective protrusions.

13. The battery adapter unit of claim 11, wherein the battery of the first type is a Lithium-ion battery.

14. The battery adapter unit of claim 11, wherein the battery of the second type is a lead acid battery.

15. The battery adapter unit of claim 11, wherein the automatic clay thrower is configured to operate in an operating voltage, and wherein the switch is configured to disconnect the transformer from the circuit based on the detected rated voltage of the battery of the first type.

16. The battery adapter unit of claim 15, wherein the switch is configured to disconnect the transformer from the circuit if the detected rated voltage of the battery of the first type is within the operating voltage.

17. A battery adapter unit for adapting a replacement battery of a first type for powering a host apparatus designed to operate with a battery of a second type, wherein the first and second battery types are different, comprising:
a housing having an upper housing portion defining a battery receptacle area having a pair of input terminals to engage with battery contacts of the replacement battery and a lower housing portion having a first pair of protrusions defining a first recess therebetween;
a lever slidably disposed in the battery receptacle area and defining a catch to engage a corresponding projection on the replacement battery when slidably received in the battery receptacle area and to partially slide with the replacement battery between a first position and second position when the catch is engaged with the projection, the projection corresponding to the rated voltage of the replacement battery;
a pair of output terminals mounted to the housing for electrical connection to the host apparatus;
one of the output terminals mounted in the first recess; and
a circuit configured to be electrically connected to the replacement battery via the input terminals and to the pair of output terminals, the circuit comprising:
a transformer configured to adjust the voltage provided from the replacement battery and supplied to the output terminals; and
a switch responsive to the lever to connect or disconnect the transformer from the circuit in response to the position of the lever.

18. The battery adapter unit of claim 17, wherein the battery of the second type is a lead acid battery.

19. The battery adapter unit of claim 17, wherein the battery of the second type is a lead acid battery.

20. The battery adapter unit of claim 17, wherein the host apparatus is configured to operate in an operating voltage, and wherein the switch is configured to disconnect the transformer from the circuit based on the detected rated voltage of the battery of the first type.
